(19) United States
(12) Patent Application Publication
(10) Pub. No.: US 2006/0041564 A1
(43) Pub. Date: Feb. 23, 2006

(54) Graphical Annotations and Domain Objects to Create Feature Level Metadata of Images

(75) Inventors: Pramod Jain, Jacksonville, FL (US); Hoai Nguyen, Jacksonville, FL (US)

Correspondence Address: PRAMOD JAIN, 9000 CYPRESS GREEN DRIVE, 108, JACKSONVILLE, FL, 32256, US

(73) Assignee: INNOVATIVE DECISION TECHNOLOGIES, INC., Jacksonville, FL (US)

(21) Appl. No.: 10/711,061

(22) Filed: Aug. 20, 2004

(51) Int. Cl. G06F 7/00

(52) U.S. Cl. 707/100

(57) ABSTRACT

Disclosed is a method, system and program for creating an annotation resource and feature-level metadata for images. Annotation resource is a collection of feature-specific domain objects. A domain object contains geometry of the feature and plurality of attributes. Geometry of feature is created by graphically annotating with freeform drawing tools on a transparent layer placed on top of the image. Attribute values may be computed automatically, manually entered or hyperlinked to a resource. The annotation resource will be stored in a database separate from the image, and cataloged in a metadata repository. This will allow users to perform search based on feature-level attributes to retrieve and display the annotation resource with the associated image.

### BACKGROUND OF INVENTION

### FIELD OF THE INVENTION

The invention is related to the field of creating metadata for images for the purposes of cataloging, searching and retrieving images, and in particular to graphical application to identify features in images, to associate properties with features, and to catalog, search and retrieve images based on feature specific criteria.

In general, an annotation is an explanatory note. In conventional methods, image annotations take the form of text-based comments or notes.

Metadata of an image is data for the purposes of cataloging, searching and retrieving the image. Metadata is domain specific and several standards exist and have been proposed for metadata elements. Most commonly used metadata elements for images from earth observation satellites, or reconnaissance aircraft are parameters related to what, when and how of the image: What is described in terms of geo-location, when is described in terms of time of image capture, and how is described in terms of equipment type, distance to object, exposure and other photography parameters. In addition, annotations that are textual descriptions of the image may be part of the metadata. These describe features in the image. In conventional feature-based image cataloging and retrieval systems, features of the image are described by user-created text-based annotations. An instance of annotation text describing the features, lesions, contained in a medical image is: “Notice the cluster of small lesions on the top-left corner of the image. These are probably benign. But the larger lesions in the same area are not”. Such metadata elements, that are textual annotations, produce ambiguous deictic references. This is because users, other than the author of the annotation, may disagree on which lesions the annotation is referring to in the image. Furthermore, if two users create document their interpretations through textual annotations of features, then the task of disambiguating ambiguous deictic references requires the two users to be face-to-face or in a collaborative environment like a white-board where the two users can view the same image and view each other's pointing devices. In addition, these conventional image retrieval systems employ one or combination of keywords to query the metadata database. The search is performed in the textual annotation fields that pertain to features in the image. In the above example user can successfully query “small lesions.” But users cannot perform queries like find images that contain area of lesions<0.1 sq. mm, x_location<5 mm, y_location<5 mm and type=benign.

In automated image processing systems, pixel data is used to compute and draw the geometry of features. This geometry and other pixel related properties are stored in a domain object. These systems allow users to enter values for other properties. In addition, users can enter textual properties, similar to the example in previous paragraph. An instance is: “Notice the cluster of small lesions LS1, LS5, LS6, LS7 and LS9. These are probably benign. But the larger lesions L2 and L8 are not”. In this instance the image processing algorithm would have labeled the lesions LSi, where i is an integer from 1 to number of lesions detected. Overlay not possible, hyperlinks not possible, computing rate of change of properties is not possible.

But these systems lack flexibility to add new features on-the-fly or add new properties to existing features. Ability to detect a new feature requires extensive programming and change to the structure of database in order to detect new features.

It would thus be desirable to have a metadata system that allows creator of metadata to specify deictic references graphically and for a method to allow user of metadata to understand deictic references unambiguously. In addition, it would be desirable to query an image metadata using structured comparisons like area of lesion<0.1 sq. mm.

### SUMMARY OF INVENTION

An object of the present invention is to describe a method for creating a resource that contains graphical, attribute-based and descriptive information about features in an image. This is called an annotation resource. It is cataloged in a metadata repository and stored in an annotation repository.

In an annotation resource, graphical annotations are used to identify or mark features in an image, while attributes and descriptions are used to describe the features. Graphical annotations are created in a web browser, by drawing on a transparent layer placed on top of the image to mark features. Attribute values for the annotated features may be computed automatically or manually entered by user or hyperlinked to resources on the web.

The benefits are: in traditional systems search engines for images rely on metadata for the images, which do not contain feature level information; in the present invention, both metadata for images and annotated resources are searched. When an annotation resource is retrieved, the detailed annotations are displayed with the associated image.

### BRIEF DESCRIPTION OF DRAWINGS

FIG. 1 is an illustration of the process of annotation of images and attribution of features in images to create annotation resources, and subsequently catalog and archive them.

FIG. 2 is an illustration of an annotation layer, which a transparent layer, placed on top of image. In the currently preferred embodiment, image and transparent layer are both displayed in a web browser. Each user creates an annotation layer.

FIG. 3 illustrates the use of and user interface components of the system for annotating an ophthalmic image of the retina in the currently preferred embodiment of the present invention.

FIG. 4 illustrates the use of the annotation system to assign values to attributes of a user-selected feature, in the currently preferred embodiment of the present invention.

FIG. 5 illustrates the use of the annotation system to calibrate images, in the currently preferred embodiment of the present invention.

FIG. 6 is a class diagram illustrating the classes and their relationships in the object-oriented model of the annotation system in the currently preferred embodiment of the present invention.

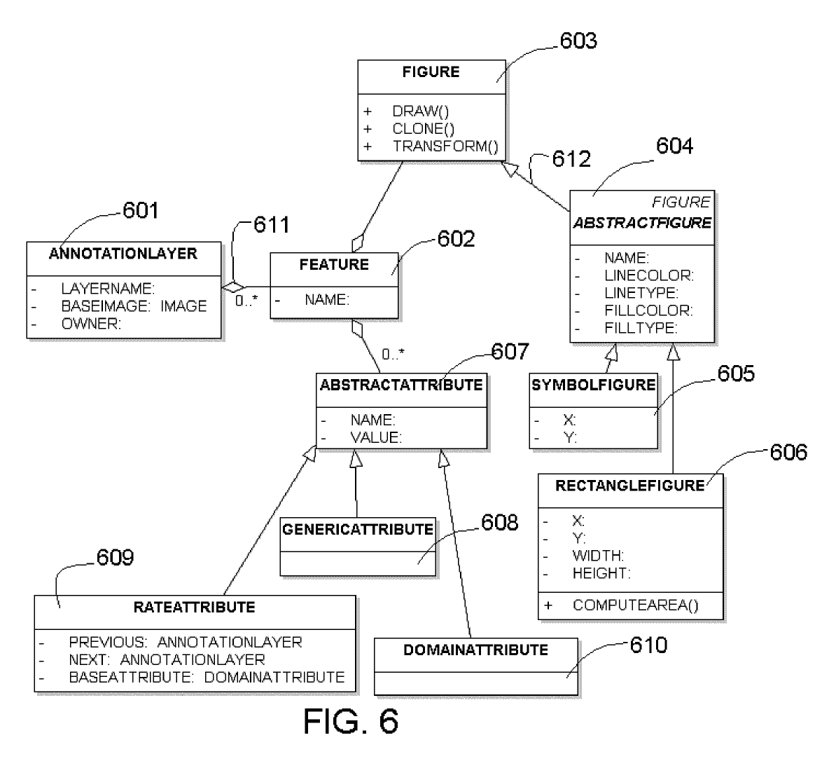

FIG. 7 is a block diagram illustrating the technical architecture of the annotation system OLE_LINK1 in the currently preferred embodiment of the present inventionOLE_LINK1.

FIG. 8 illustrates the process of searching for annotation resources. If user selects an annotation resource for viewing, then the graphical annotations are displayed in an annotation layer placed on top of the associated image.

FIG. 9 illustrates a flow diagram of how a retrieved annotation resource is extracted from database, processed by middle-tier and displayed in the browser.

FIG. 10 is an illustration of how multiple layers are over-laid on an image. In the currently preferred embodiment, image and the transparent annotation layers are all displayed in a web browser.

FIG. 11 illustrates the logic for creating layers and annotated features with attributes using Scalable Vector Graphics XML.

FIG. 12 illustrates a flow diagram of the logic of computing temporal attributes of features in layers.

FIG. 13 illustrates the process of searching for annotation resources using advanced search criteria. In the currently preferred embodiment search criteria may include numerical attributes and their rates.

### DETAILED DESCRIPTION

The following terms are used in this description and have the indicated meanings:

Metadata is data about data; data that describes resources like images and annotation resources.

Metadata Repository is a central store for metadata of resources like images and annotation resources. It provides ability to search for metadata records.

Feature in image: An area of interest to a user in the image. Examples of features are: eye of storm or cloud cover in satellite infrared image; lesion in a fluorescein angiography of the retina.

Rich Annotation to a feature in an image: A multimedia explanatory note about the feature in the image. Annotation may be a combination of graphics, text, structured data, audio and other forms of multimedia data. The present invention is focused on identifying and describing features in images. Each feature of interest will be identified and described through a rich annotation, which is a collection of annotations where at least one of the annotations is graphical.

Annotation layer: A transparent drawing canvas placed on top of an image on which graphical component of rich annotations are created by drawing in free form or placing symbols. Annotation Resource is a collection of rich annotations created on a single layer. It is a resource that is used to mark and describe features in an image. Annotation resource Metadata of an annotation resource is stored in a metadata repository.

Domain object class: A set of attributes to describe data and methods in a particular domain. A domain object class will specify attributes and methods for a specific type of feature.

Domain object: It is an instance of domain object class. It stores data in a particular domain. A domain object will store all data pertaining to a feature, that is domain object will store all data pertaining to a rich annotation.

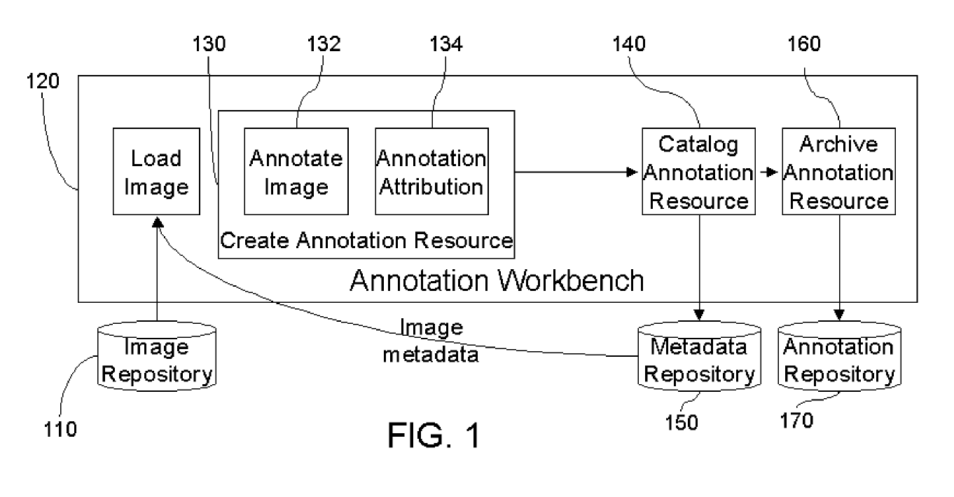

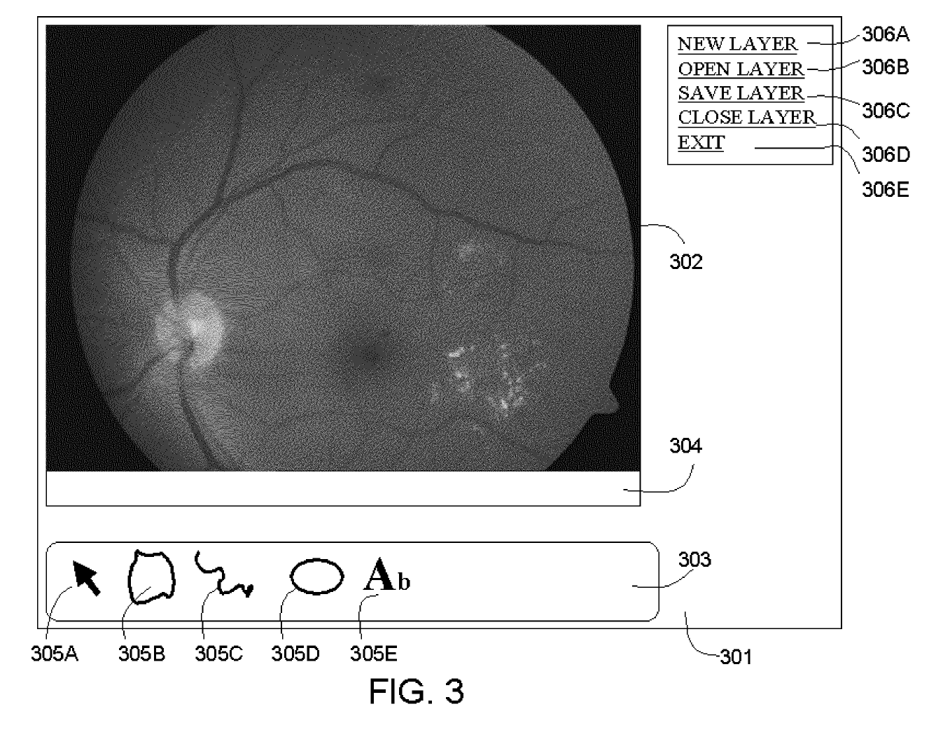

The overall process of creating annotation resources in the currently preferred embodiment of the present invention is illustrated in FIG. 1. First step is to retrieve an image from the image repository (110) and place it in the background in the image annotation system (120, described in FIG. 3). The image is annotated by marking features (132), and describing the features with combination of attributes and descriptions (134). This creates an annotation resource (130), which is cataloged (140) into the metadata repository (150) and archived (160) in the annotation repository (170).

In sequel the process of creating rich annotations will be described.

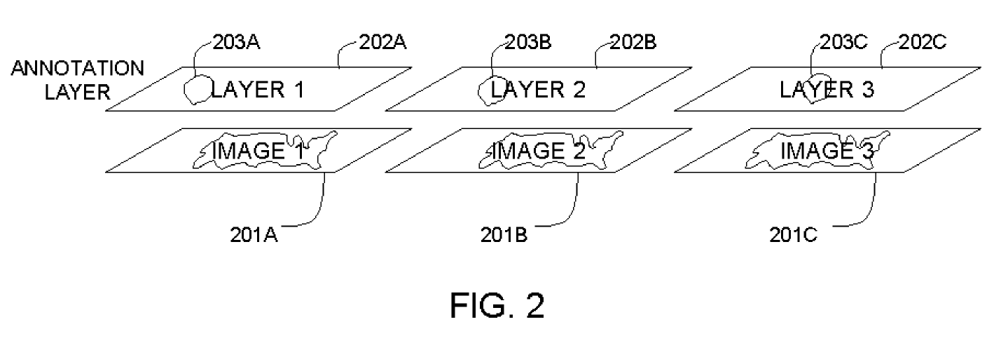

FIG. 2 illustrates the image annotation system in which a transparent annotation layer is placed on an image and an annotation 203A is created. In the currently preferred embodiment of the present invention, the image (201A) is displayed in a web browser. However, the image can be displayed on different implementation of image rendering program. A transparent annotation layer (202A) is created on which user action with mouse or other pen-based devices can be tracked. On this annotation layer, a user can draw using a variety of tools, similar to those available in any Windows based Painting programs, or place a icon on the annotation layer. Note that the image in 201A is not touched by the annotation. 201A, 201B and 201C are collection of images, and a user or multiple users may create annotations (203A, 203B, 203C) on client computers that are connected to a server computer. Image 201A will be referred to as the base image for Annotation layer 202A.

In the currently preferred embodiment of the present invention, the SVGViewer plugin to the web browser, provided by Adobe Corporation, captures cursor movement on the web browser. The cursor position and action are then passed through the SVG's Application programming interface (API) to an application. In the current embodiment, the application has been developed using JavaScript language.

As shown in FIG. 3, user annotates a feature in the retinal image (302) by picking an annotation tool (305A, 305B, 305C, 305D, 305E) for the feature type from the toolbar (303), and uses it to draw in the annotation layer (304). The toolbar contains a plurality of drawing tools, one for each feature type. Management if annotation layers is done through standard activities in 306A, 306B, 306C, 306D and 306E.

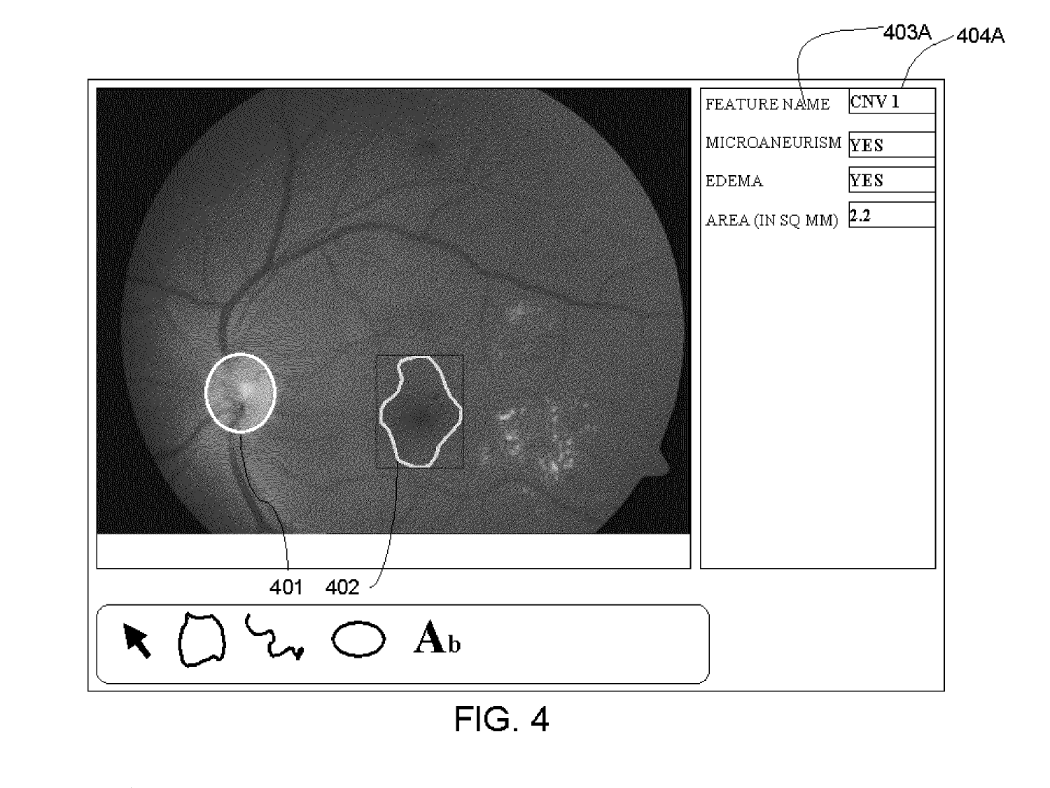

In FIG. 4, two features have been annotated, optic disk (401) and CNV lesion (402). After user creates a feature in the annotation layer, user can name the feature and assign values to attributes associated with the feature type. The current selection is CNV Lesion, and on the right-hand panel attributes are displayed for the selected lesion. CNV Lesion has the following attributes (403): Microaneurism, edema and area. Values (404) for the first two attributes are entered by the user and values for area are automatically computed based on standard methods for computing area of closed figures and a calibration factor for distance per pixel.

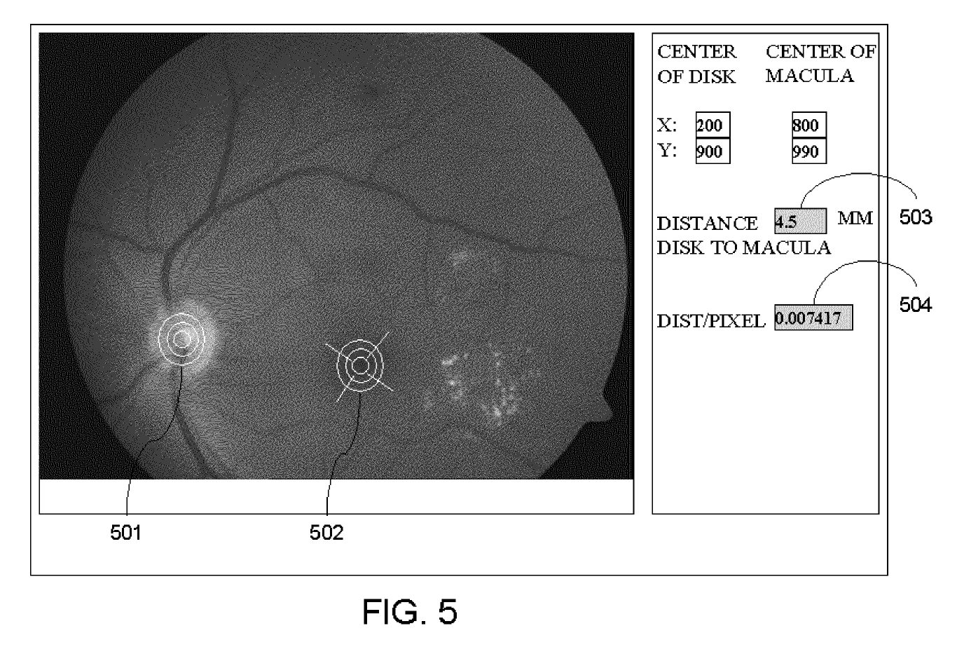

Method for calibration is illustrated in FIG. 5. Two known points in the retinaOptic disk and Macula are marked by placing symbols 501 and 502. The distance between the two markers is 4.5 millimeters (503). So the calibration factor is computed based on real world distance divided by the distance in pixels (504). Once the image is calibrated, geometrical attributes like area and length of annotations are automatically computed in real world coordinates. Area is computed using the Green's theorem, and length is computed using the metric distance between two points. These are standard methods for computation and will therefore not be described in detail.

The act of creating an annotation for a feature creates a domain object for the feature, which is an instance of the domain object class for the feature type. All data associated with the feature are stored in the domain object, including the geometry of the feature. The class diagram for the domain object is illustrated in FIG. 5. Figure (503) is an interface class, and AbstractFigure (504) is the parent class of all figures, like SymbolFigure (505), RectangleFigure (506), OpenPath, ClosedPath and others. Feature (502) is an aggregate class that contains Figures, and Attributes. Abstract Attributes (507) is the parent class of different types of attributes like GenericAttributes (508), DomainAttributes (510) and RateAttributes (509). The Annotation Layer (501) contains one or many Features.

In the currently preferred embodiment of the present invention, the domain object for each type of feature (502) is stored in the database. When a feature type is loaded into an annotation toolbar, then the domain object is created using javascript and stored in the browser's Document Object Model (DOM). When a feature is created on an annotation layer (501), then an instance of the domain object is created for the feature. This object is populated with the geometry and attribute values of the feature. The geometry of the annotated feature is stored in Scalable Vector Graphics format, an XML based format for storing 2D graphics.

Other generic attributes (508) that are automatically assigned values are: Creator of resource, Date/Time of resource creation, link to the image associated with the resource, and any other metadata associated with the image that is deemed useful by the domain administrator. The attribute values that are not computed in an automated manner are entered manually. The attribute values may be numbers, text or hyperlinks to other resources. The list of attributes associated with a feature is displayed in a HTML form for data entry. Examples of these domain attributes (510) are, in the domain of retinal images in ophthalmology for CNV lesions are: micro-aneurisms, drusen, edema, leakage, etc. User can author a summary for the annotation resource of an image. This summary can contain hyperlinks to the annotated features on the annotation layer.

When user draws in a web browser using a mouse or a pen-based device, the coordinates are captured using javascript, and then converted into SVG format and sent to the SVG plugin for rendering. This SVG format is used for storing the geometry of the drawing. An annotation layer may contain many annotations, including multiple annotations of the same feature type. Annotations can be moved, rotated, stretched, copied, pasted and deleted.

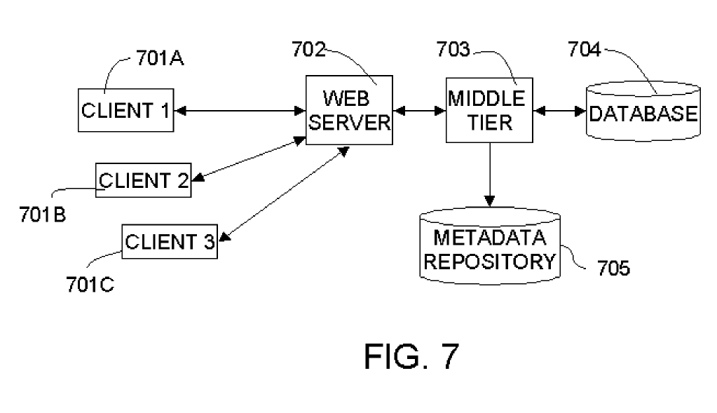

The high-level process of saving of domain object is illustrated in FIG. 7. When user chooses to save the annotation layer, the client program (701) serializes the domain objects and sends to the middle-tier application (703) through the web server (702). The middle-tier (703) performs two steps: a) deserializes the serialized object to extract the individual data elements in the domain object of the features and updates the metadata table in the database (704), b) saves the serialized object in the database in a CLOB field. The reason for step a) is to allow cataloging of image based on data in the domain object and to create a metadata file for the annotation resource, and reason for step b) is to efficiently load an existing layer from the database.

Although there are standards (Dublin Core) for metadata records for cataloging images and other digital resources, standards for annotation metadata are still in infancy. In the currently preferred embodiment of the present invention, the NSDL Annotation metadata schema will be used to generate metadata records for annotation resources. The metadata record is an XML file. In the currently preferred embodiment of the present invention, the XML file is converted into a template and middle-tier is used to populate content into the XML template file. The XML template file contains ASPIRE tags that are replaced with data by the ASPIRE middle-tier to create the metadata file for an annotation resource. There are several methods of generating the XML metadata file and ASPIRE middle-tier and tag-based approach is chosen for convenience. A mapping of the data elements of domain object and ASPIRE tags in the template file is created in ASPIRE properties file. All the attribute names and all non-numeric attribute values in an annotation resource are stored as keywords in the metadata record for the said annotation resource. This enables the metadata repository's search engine to search based on attributes and attribute values.

A standard metadata record contains information like title, author, dates and URL pointing to the location of the digital resource. A domain specific metadata schema uses the standard metadata schema and extends it to meet the needs of the domain. In the currently preferred embodiment of the present invention, the domain specific metadata schema will contain a field for specifying the parent metadata record. In the parent field of the metadata record of the annotation resource, a link to the metadata record of the image will be stored. Although a parent field is not required for this invention, such a field will enable the search results to display information about the parent record. For instance, when the search results display the metadata record for an annotation resource, the associated parent record corresponding the image will be displayed.

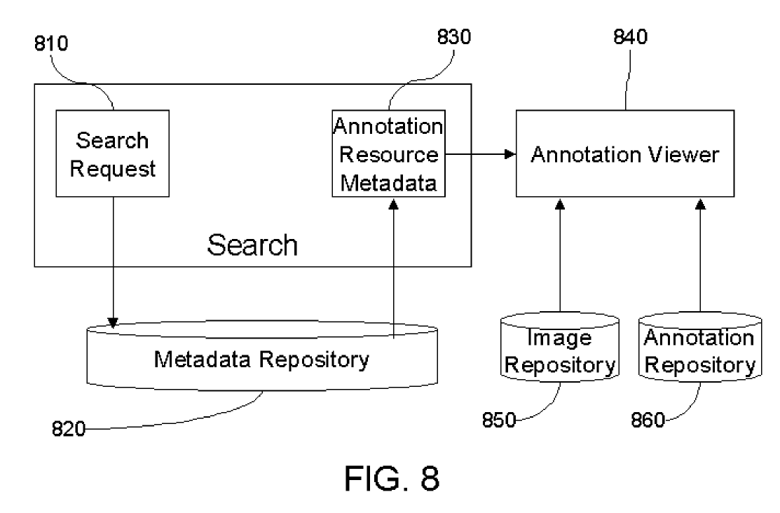

The search process is described in FIG. 8. The search parameters in a search request (810) include keyword and advanced search criteria that include attributes and range of attribute values. The metadata repository (820) returns annotation resource metadata records. In the preferred embodiment of the present invention, the display of search results will contain URL of the annotation resource. When the URL is clicked, then the web browser-based annotation viewer (840) is invoked that displays the image obtained from image repository (850) and annotation layers from the annotation repository (860).

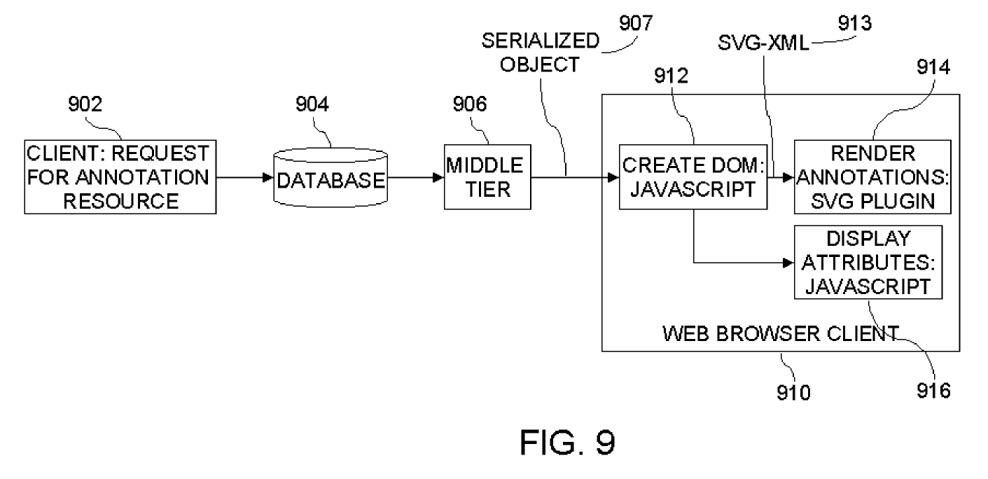

When user chooses the above URL by clicking on it, then the chosen annotation resource (902) will be rendered in an annotation layer placed on top of the associated image; the process of rendering the annotation resource is shown in FIG. 9. The serialized domain object (907) for the said annotation resource is delivered to the web browser (910). JavaScript extracts all attributes in the domain object to create an instance in the Document Object Model (DOM, 912). JavaScript extracts the SVG-XML (913) from the DOM and delivers to browser's SVG plugin for rendering (914). The other attributes from the DOM are used to populate the object model and displayed on HTML page using JavaScript (916).

A method for tracking features and their attributes, in a sequence of two-dimensional images, and storing in the annotation resource is part of the innovation. The sequence of images may be generated by taking an image over a period of time of the same area or generated by taking parallel slices of a three-dimensional image. A user or multiple users may annotate the sequence of images and create one or many annotation layer(s) for each image in the sequence.

Overlay of multiple layers enables user to a) understand in a graphical manner changes to feature location and geometry in a sequence of 2D images that are slices of 3D image or images taken over a period of time, and b) visually compare interpretations of multiple users with respect to features in a common image.

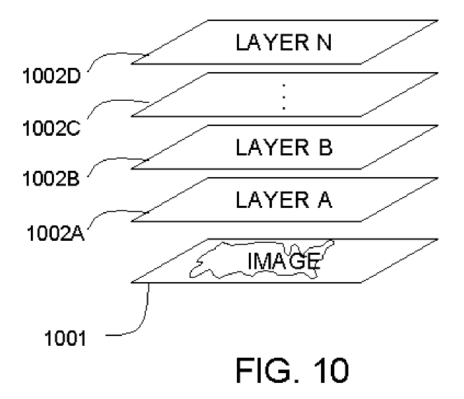

Users with appropriate authorization will be able to overlay multiple annotation layers (1002A, 1002B or 1002C, 1002D) on top of one of the base images (1001), see FIG. 10. During overlay, each annotation layer is assigned a value for opacity between 0 and 1. The top layer is assigned an opacity of 1, and the underneath layers are assigned lower opacities. This creates a visual effect such that users can easily determine that the most opaque annotations belong to the top layer and less opaque annotations belong to other layers. Since the annotation layers are transparent, user is able to see the image.

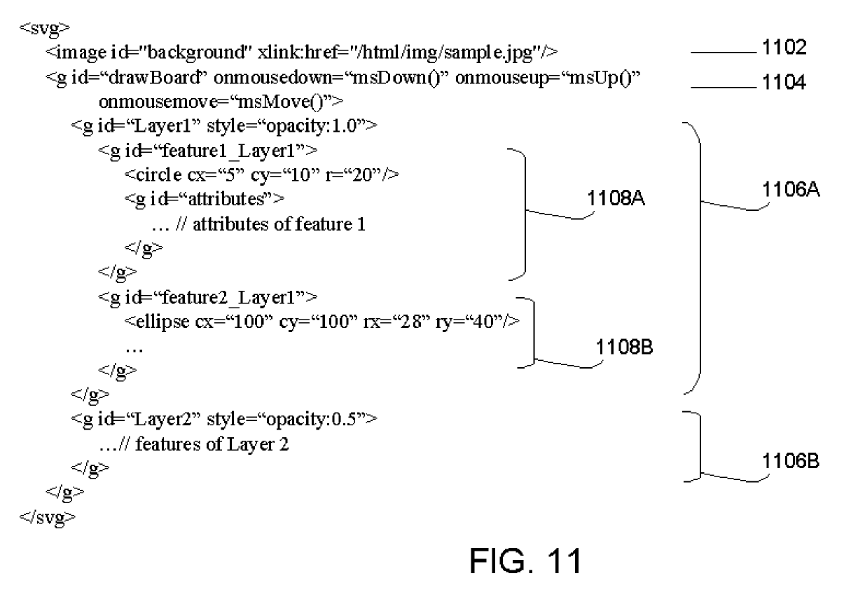

Each layer is implemented as a class that is a collection of features. The layer class has functions that: can receive a serialized object of an annotation resource and create an annotation layer; can create a serialized object of all the annotations in a layer and save in database. FIG. 11 illustrates how all this is achieved in SVG, from a graphical perspective; the background image is specified in 1102. Each layer is contained in a separate group (1106A, 1106B), and DrawBoard (1104) group manages mouse interaction for all the layers. The functions responsible for managing user actions of drawing with the mouse (msDown( ), msUp( ) and msMoveo( )) act only on the top layer and not for all other layers. Features in “layer 1” are specified as two groups 1108A and 1108B inside layer 1106A.

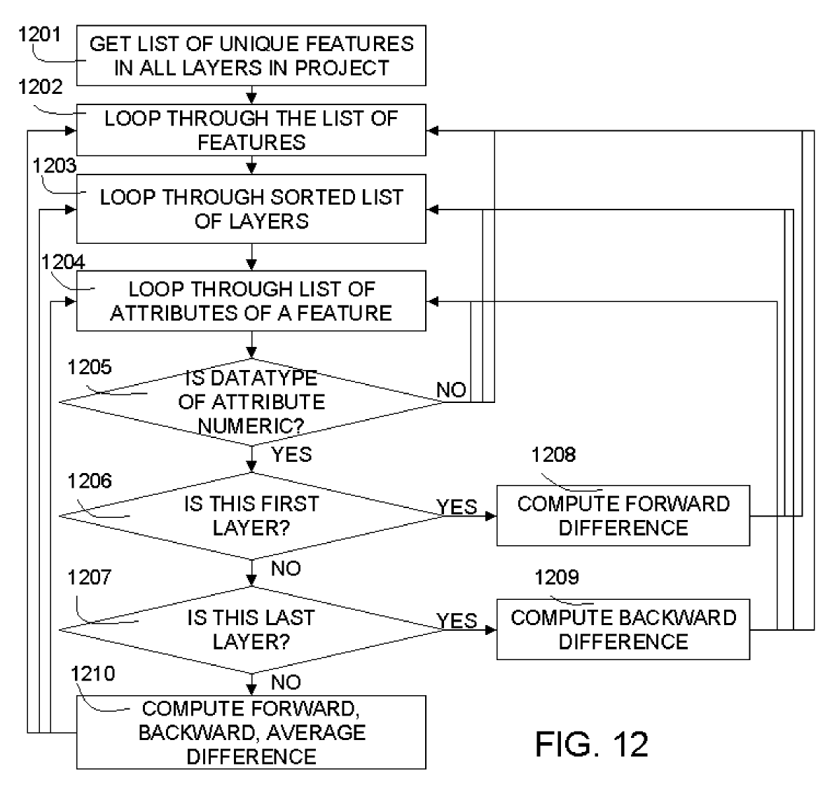

The logic for this computation of differences between attribute values of annotations in two or more layers is shown in FIG. 12. Three quantities are computed: forward difference, backward difference and mean difference of attributes (1208, 1209, 1210). This applies to only those attributes that have numerical values. User chooses the layers to compare and overlays them on a base image. The three difference attributes for a layer are computed and stored in the database for each numerical attribute.
Backward difference(i)=param(i) param(i−1)
Forward difference(i)=param(i+1) param(i)
Average difference(i)=(Backward difference(i)+Forward difference(i))/2

Where i=1 to n is the layer index.

Since the sequence of images may be temporal or slices of a 3D image, the rate is computed based on UOM of the third dimension, which is time or distance. For example the rate of change of area may be: 10 sq mm per month or −0.5 sq mm per micron. Such rate information is stored in database as metadata for features in a sequence of images. In the currently preferred embodiment of the present invention, only the temporal rate data is computed; computation of 3D rate information is a simple extension for any programmer familiar with sequence of images.

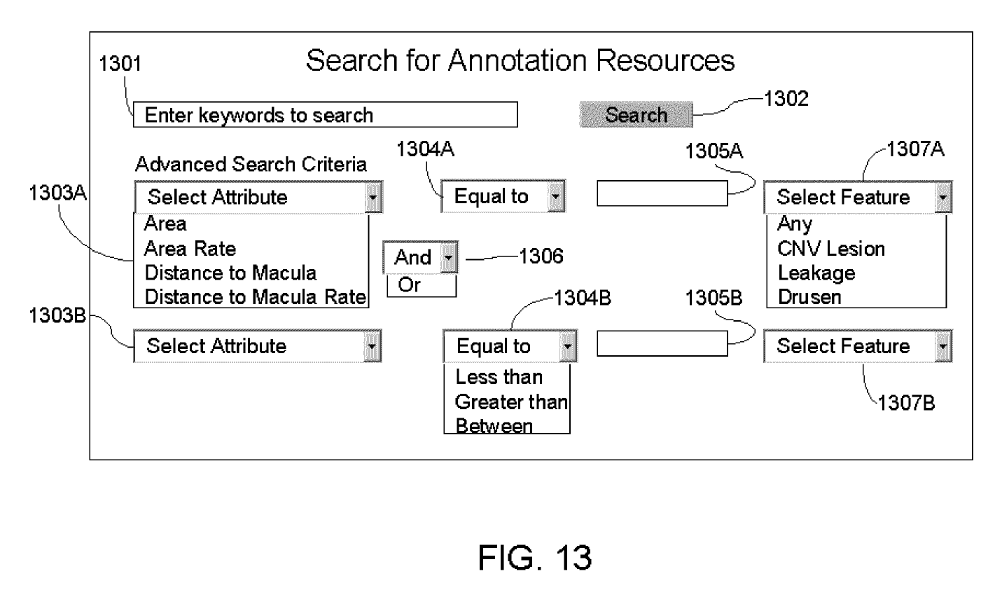

The rate information above is also a basis for searching of annotation resources. FIG. 13 illustrates user interface for searching based on rate. Users can enter keywords (1301), choose attribute or attribute rate (1303A, 1303B), choose relationship (1304A, 1304B), choose conjunction type (1306), enter values (1305A, 1305B), and choose the feature type (1307A, 1307B). An example of a search query is: Find annotation resource with “keywords=macula AND AREA of CNV lesion is GREATER THAN 10 sq mm AND AREA RATE of CNV lesion is LESS THAN 0.5 sq mm per month. In the currently preferred embodiment of the present invention, only two advanced search criteria can be specified; addition of more criteria is a simple extension for any programmer familiar with user interface and dynamic query generation.

While the invention has been described in terms of a single preferred embodiment, those skilled in the art will-recognize that the invention can be practiced with modification within the spirit and scope of the appended claims.

1. A system for creating annotation resources, for an image, comprising:
a. A method to identify feature in the said image by drawing, an annotation in a free form manner in a transparent annotation layer placed on top of the said image, with an annotation tool that is specific to the type of the identified feature;
b. A method to generate a domain object for the identified feature from a domain class definition that is specific to the said feature type, where the said domain class definition specifies a list of attributes;
c. A method to automatically compute values for some of the said attributes, and a method for users to enter values for rest of the said attributes;
d. A method to store the annotation geometry of the said feature in the said domain object;
e. A method to store the said domain objects of the said features in database or file;
f. A method to create metadata for the annotation resource

2. A method for searching, retrieving and graphically rendering the said annotation resources, comprising:
a. A program to allow user to enter keywords and/or enter attribute names, attribute values and relationships like equal to, less than, greater than, between and others, for the purposes of searching metadata
b. A program to use the search parameters entered in a) to find metadata records in database that meet the said search criteria for display as a list, to retrieve the annotation resource selected by user from the list, and display the annotation resource with the associated image in background
c. A program to display the annotation resource creates a transparent layer and renders annotations in said transparent layers
d. A program to display all the attributes of an annotated feature contained in the said annotation resource, when the said annotation is highlighted

3. A method for tracking features and their attributes, in a sequence of two-dimensional images that are generated by taking an image over a period of time or generated by taking parallel slices of a three-dimensional image, and storing the tracking data in the domain objects of annotation resources, comprising:
a. A program to overlay multiple transparent annotation layers corresponding to each of the sequence of images
b. A program in which user chooses the background image on which the said multiple layers are overlaid
c. A program in which the differences in attribute values are computed and stored in a user specified annotation resource
